(19) United States
(12) Patent Application Publication
(10) Pub. No.: US 2007/0012262 A1
(43) Pub. Date: Jan. 18, 2007

(54) HANDS-FREE DOG LEASH

(76) Inventor: Emilia M. Cole, Chicago, IL (US)

Correspondence Address: BELL, BOYD & LLOYD, LLC, PO BOX 1135, CHICAGO, IL, 60690-1135, US

(21) Appl. No.: 11/381,046

(22) Filed: May 1, 2006

Related U.S. Application Data
(60) Provisional application No. 60/699,766, filed on Jul. 14, 2005.

(51) Int. Cl. A01K 27/00

(52) U.S. Cl. 119/797

(57) ABSTRACT

The present invention relates to a hands-free leash comprising a length, a body, an opening in the body, and a first connector attached to the body. The length of the leash is manually adjustable by linking the first connector to the opening defined in the body. In an embodiment, the leash includes a container secured thereto with a plurality of storage compartments for retaining miscellaneous items therein.

### PRIORITY

This application claims priority under 35 U.S.C. 119(e) to provisional application Ser. No. 60/699,766 filed Jul. 14, 2005.

### BACKGROUND

The present invention relates generally to dog leashes.

Walking or running a dog with a leash is a leisurely activity that many pet owners enjoy. However, this activity can be unnecessarily uncomfortable for users of conventional leashes because many dogs, even the most obedient ones, have a tendency to move about sniffing and exploring their surrounding environment. These erratic movements can interrupt the user's natural walking/running rhythm and can force the user to continuously alternate the hand in which they are holding the leash. These disruptions can be a real annoyance for the user and cause what is supposed to be a very enjoyable and relaxing experience to be less than pleasant.

Hands-free leash eliminate the need to continuously alternate the hand in which the user holds the leash and minimizes disruptions in walking/running rhythms. But currently available hands-free leashes have limited functionality. For example, because the hands are not being used, the ability to keep the dog at a comfortable distance from the user is critical for maintaining control over the dog's movements. Yet the means for adjusting the length on current hands-free leashes can be unnecessarily difficult and time consuming to operate.

In addition, dog owners that enjoy taking their dogs on long distance walks or runs often bring miscellaneous items such as dog treats, watches, cell phones, keys, candy, or water, along with them. To carry these items, backpacks, pouches, purses or other storage containers often accompany such extended trips. But carrying these containers can be both cumbersome and annoying for a user, particularly for those users that carry a backpack and prefer running with their dog.

### SUMMARY

The present invention relates generally to a hands-free leash that overcomes the limited functionality of the currently available hands-free leashes. The present invention has a length, a body, an opening in the body, and a first connector attached to the leash for manually adjusting the length of the leash by linking the first connector to the opening in the body. This adjustability feature allows users to easily control the distance from their dog enabling them to limit the dog's erratic movements and allows users to quickly alter the length of the waistline to provide a more comfortable or appropriate fit. In one embodiment of the present invention, the leash has a plurality of openings to adjust the leash to any number of lengths to fit a particular user's preference, wherein the openings are defined between first and second layers of vinyl webbing material.

A container for storing miscellaneous accessories may also be attached to the body of the leash and include a plurality of easily accessible storage compartments. Each storage compartment can have at least one of a plurality of closing mechanisms such as a draw string, a flap, or a hook and loop fastener to ensure the user's accessories will be safely retained in each of the compartments.

Additional features and advantages are described herein, and will be apparent from, the following Detailed Description and the figures.

### BRIEF DESCRIPTION OF THE FIGURES

FIG. 1 illustrates a perspective view of a dog leash in an embodiment of the present invention.

FIG. 2 illustrates a perspective view of a portion of the dog leash in an embodiment of the present invention.

FIG. 3 illustrates a perspective view of a first connector linked to an opening in the body of the leash in an embodiment of the present invention.

FIG. 4 illustrates a perspective view of a dog leash having first and third connectors linked to openings in the body of the leash in an embodiment of the present invention.

FIG. 5 illustrates the dimensions of the leash in an embodiment of the present invention.

### DETAILED DESCRIPTION

The present invention generally relates to a dog leash. More specifically, the present invention relates to a hands-free dog leash with connectors and openings for manually adjusting the length of the leash. As used herein, “hands-free leash” means a leash designed to be secured around a portion of the body not including the hands.

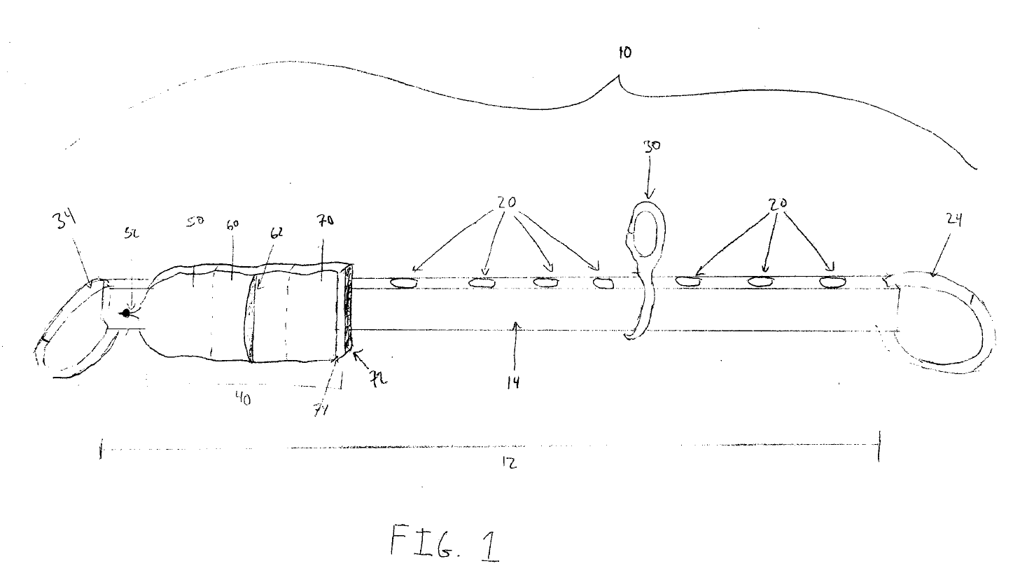

Referring now to the drawings wherein like numerals refer to like parts, FIG. 1 generally illustrates a perspective view of an embodiment of a dog leash 10 having a manually adjustable length 12. The leash may be fabricated using any suitable high strength and durable material such as, nylon or canvas. In one embodiment, the leash is composed of a vinyl webbing material doubly reinforced to enhance the mechanical strength and durability of the leash. A leash made from a reinforced high strength material such as nylon is able to withstand pulling and yanking forces from larger dogs as well as tolerate a minimal degree of chewing.

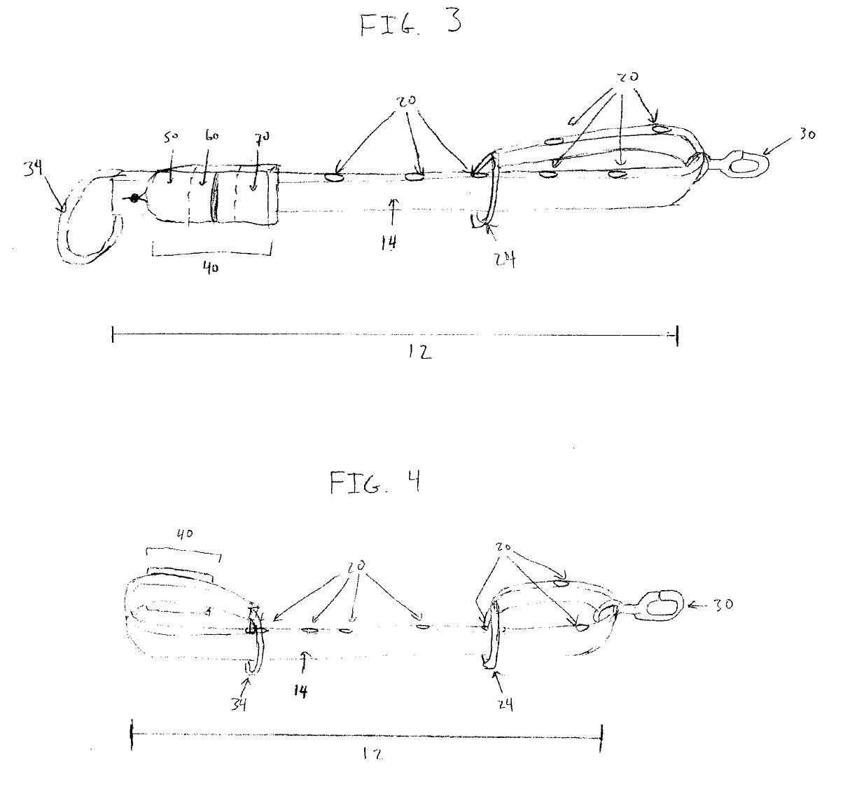

The leash 10 includes a body 14 with a plurality of openings 20 and a first connector 24 attached to the proximal end of the leash. As illustrated in FIG. 3, the length 12 of the leash 10 is adjustable by manually linking the first connector 24 to one of the openings 20 in the body 14. The openings 20 may be formed as slots between two strips of leash material, as holes punched in the leash material, or in any other form enabling the first connector 24 to be linked to an opening 20. Other embodiments may contain more or less openings 20 within the body 14 of the leash. The first connector 24 may be a carabiner or any alternative mechanical fastener or connecting device such as a clip, latch, or clasp. The means for adjusting the length of the present invention allows user to easily adjust their distance from the dog to maintain better control of the dog's movements and permits easy use by those with arthritis or other hand ailments.

A second connector 30 is slideable along the length 12 of the body 14 of the leash 10 and can be attached to one of an animal collar or harness (not depicted). The second connector 30 is shown illustrated in the embodiment of FIG. 1 as a clip, but any alternative mechanical fastener or connecting device such as a carabiner, latch, or clasp may be used.

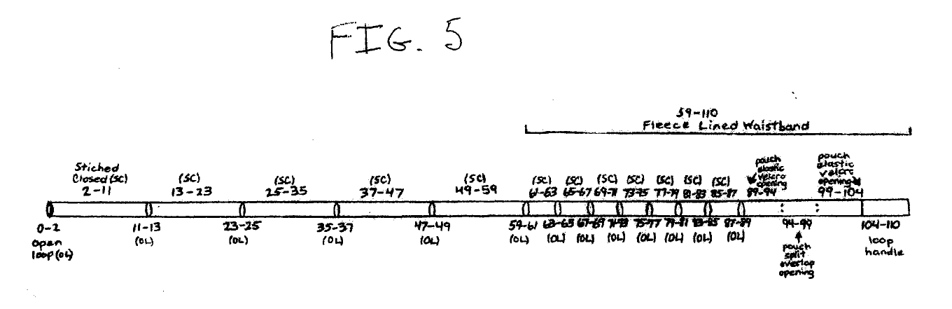

A third connector 34 is attached to the distal end of the leash and is linkable to any of the openings 20 for further adjusting the length of the leash 12. As illustrated in FIG. 4, the length 12 of leash 10 has been adjusted by linking the first connector 24 to one of the plurality of openings 20 and the third connector 34 to another of the plurality of openings 20. The adjustment shown in FIG. 4 alters the length the leash 20 to comfortably fit around a given user's waistline. This adjustment allows users to walk their dog with their hands free for other activities such as maintaining balance when the dog is pulling in unwanted directions, picking up dog waste, or using accessories such as a cell phone. In addition, having the leash secured around the waist rather than in the hand permits users to use the core of their body, rather than their arms and upper back to control their dog's movements. The third connector 34 may be a carabiner, as illustrated in the embodiment shown in FIG. 1, or any alternative mechanical fastener or connecting device such as a clip, latch or clasp.

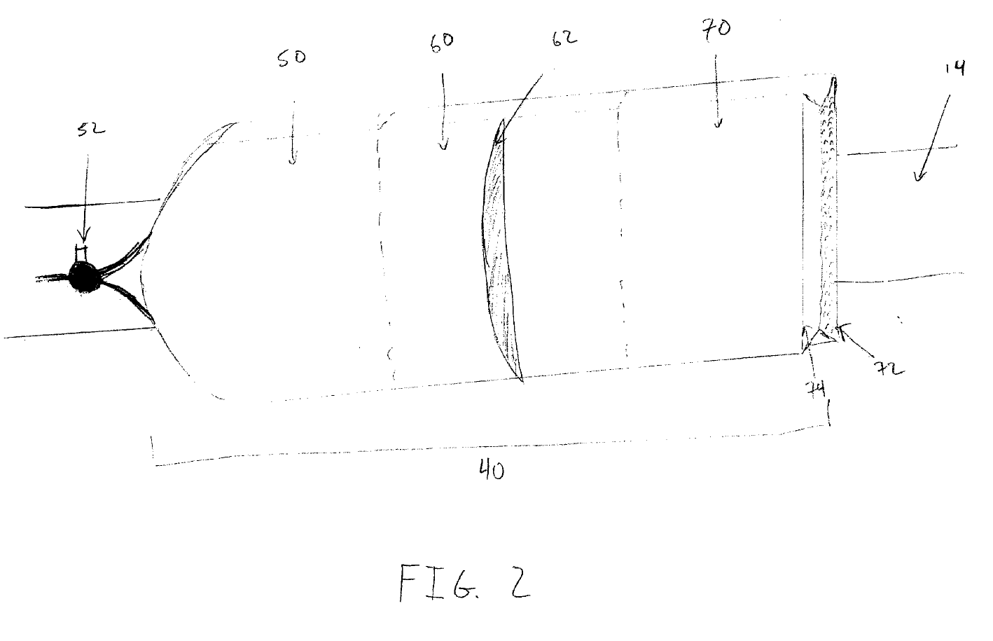

Referring now to FIG. 2, a storage container 40 is attached to the body 14 of the leash 12 with a plurality of holding compartments. In an embodiment, the plurality of holding compartments includes a first compartment 50, a second compartment 60, and a third compartment 70. The container 40 can have more or less than the three holding compartments illustrated in the embodiment of FIG. 2. Each holding compartment allows the user to conveniently store items such as dog biscuits, dog waste bags, keys, identification cards, money, food, electronic devices or other miscellaneous items that may be used while walking or running with a dog. The container 40 may be secured, removable from, or slideable along the body 14 of the leash 10. The container 40 can be constructed from any durable and/or waterproof materials such as acrylic, canvas, nylon, or plastic.

To prevent items from falling out of the container 40, each storage compartment of the container 40 may include a closing mechanism. For example, in one embodiment, the first storage compartment 50 includes a draw-string 52, the second storage compartment 60 includes a flap 62, and the third storage compartment 70 includes a hook and loop fastener. Other suitable closing mechanisms such as snaps, buttons, magnets, or zippers may be used for any one of the first, second, and third storage compartments. In the illustrated embodiment, the flap 62 is drawn over the opening to close the second storage compartment and drawn aside to reveal the opening. The third storage compartment 70 has one open end with a patch of hook material 72 and a patch of loop material 74 sewn therein. The hook material 72 and the loop material 74 are pressed together to close the third storage compartment. The closing mechanisms prevent the user's accessories from accidentally falling out of the storage compartments while walking or running with their dogs on the leash.

By way of example, the dimensions of an embodiment of the leash are illustrated in FIG. 5. The figure illustrates the orientation and location of the openings and container in an embodiment.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A leash comprising:
a body having a length;
an opening in the body;
a first connector attached to the body,
wherein the length of the leash is adjustable by linking the first connector to the opening in the body.

2. The leash of claim 1 further comprising:
a plurality of openings in the body,
wherein the length of the leash is adjustable by linking the first connector to one of the plurality of openings in the body.

3. The leash of claim 1 further comprising:
a second connector for attaching to an animal collar or harness,
wherein the second connector is slideable along the body.

4. The leash of claim 1, wherein the first connector is a carabiner.

5. The leash of claim 1 further comprising:
a first layer of vinyl webbing material;
a second layer of vinyl webbing material reinforcing the first layer of vinyl webbing material,
wherein the first opening is defined between the first and second layers of vinyl webbing material.

6. A hands-free leash comprising:
a body having a length;
a container secured to the body;
an opening in the body;
a first connector attached to the body,
wherein the length of the leash is adjustable by linking the first connector to the opening in the body.

7. The leash of claim 6, wherein the container further comprises:
a plurality of storage compartments.

8. The leash of claim 7, wherein each of the plurality of storage compartments includes a closing mechanism.

9. The leash of claim 8, wherein the closing mechanism is selected from at least one of a hook and loop fastener, a draw string, and a flap.

10. The leash of claim 6, wherein the container is removably secured to the body.
